(19) United States
(12) Patent Application Publication
(10) Pub. No.: US 2014/0258068 A1
(43) Pub. Date: Sep. 11, 2014

(54) SYSTEM AND METHOD FOR SEQUENTIAL COUNT VISUAL INDICATOR

(71) Applicant: CHARTIQ, LLC, Crozet, VA (US)

(72) Inventor: Terrence Thorsen, Crozet, VA (US)

(73) Assignee: ChartIQ, LLC, Crozet, VA (US)

(21) Appl. No.: 13/792,940

(22) Filed: Mar. 11, 2013

(51) Int. Cl. G06Q 40/04

(52) U.S. Cl. CPC G06Q 40/04
USPC 705/37

(57) ABSTRACT

A system and method provides for analysis and graphical display of a sequential counter for financial data. The system and method includes receiving a plurality of financial data relating to an equity, the financial data including value data of the equity over a plurality of time intervals and selecting a counting algorithm from a plurality of algorithms, for application to the financial data. The system and method further includes detecting a plurality of value steps within financial data, the value steps determined based on parameters of the counting algorithm and performing a sequential counting of the value steps based on the counting algorithm. The method and system further generates a user recommendation for the equity based on the counting and generates a graphical display including the financial data, a secondary display of the sequential counting of the value steps adjacent to the financial data, and the user recommendation.

### COPYRIGHT NOTICE

A portion of the disclosure of this patent document contains material, which is subject to copyright protection. The copyright owner has no objection to the facsimile reproduction by anyone of the patent document or the patent disclosure, as it appears in the Patent and Trademark Office patent files or records, but otherwise reserves all copyright rights whatsoever.

### RELATED APPLICATIONS

The present application relates to and incorporates herein: copending U.S. patent application Ser. No. 13/792,768 entitled “SYSTEM AND METHOD FOR DETECTION AND DISPLAY OF DIVERGENCE WITHIN A FINANCIAL DATA SET” filed Mar. 11, 2013; copending U.S. patent application Ser. No. 13/792,829 entitled “SYSTEM AND METHOD FOR DETECTION AND DISPLAY OF DIVERGENCE WITHIN A FINANCIAL DATA SET” filed Mar. 11, 2013; and copending U.S. patent application Ser. No. 13,792,890 entitled “SYSTEM AND METHOD FOR FINANCIAL GAP DETECTION” filed Mar. 11, 2013.

### FIELD OF INVENTION

The disclosed technology relates generally to graphical displays of financial information and more specifically to the processing of financial information, including the detection of one or more count sequences for financial data and the visual display thereof.

### BACKGROUND

There is a long history of trading stocks, equities or any other financial instruments. Technology has advanced the trading platforms allowing for sellers to sell and buyers to buy these instruments, evolving from early call-out systems to electronic trading platforms to high speed trading systems.

In addition to the buying and selling of instruments, there has also been the growth of price analysis. It is a natural evolution of the trading system for traders to make educated predictions on price fluctuations or movements in these trading instruments. Based on these price estimations, traders can thereby seek to make estimates of when to buy, sell or hold trading instruments, e.g. equities, such as the sequential count indicating a price exhaustion of the security.

A further growth of the analytical framework is the review and estimation of price movements based on perceived patterns or sequences of occurrences of the equity. By way of example, one known pattern is the detection of consecutive intervals of closing sequences of the equity and the counting of the consecutive down or up closes before there is a change in closing direction.

One counting sequence includes analytical rules for counting a first number of up (or down) consecutive closes, followed by a second number of down (or up) consecutive closes, and then followed by a repeat of the first number of up (or down) consecutive closes, where closes refers to the closing trading price of the equity at the end of the trading period.

Existing techniques for the counting sequences are based on one of two possible systems. A first system is the manual review of financial data, typically in the form of graphical displays, where an analyst manually locates and notes the closing prices of the equity at various intervals. The analyst then uses this tracked information to ascertain if a sequential pattern exists. This technique is extremely time consuming based on the complexity of the pattern rules. This technique is also extremely error-prone because the analysis relies on the user's inspection and detection of the financial data, understanding and implementation of the sequence rules and analysis of large amounts of graphical data.

The second system relies on a computer processing system to generate a graphical overlay on the financial data. This computing technique automatically tracks sequential rules and automatically plots the number count over the chart. This technique is problematic because the overlay display is difficult to process, requiring the eye to read and interpret numbers, requiring cognitive processing by the user. The technique is also problematic because the overlay does not illustrate to the analyst trends of almost-completed signals or completed signals that continue to meet the sequential criteria, which can be important indicators to analysts. Additionally, this overlay technique is expressly limited to the specific algorithms and the analyst cannot therein use arbitrary sequential counting algorithms or otherwise modify the algorithm. Additionally the overlay techniques currently available clutter the display and chart area on the graphical display, making it difficult for the analyst to focus on the price action.

Thus, there exists a need for a system and method to provide visual analysis and graphical representation of sequential algorithms for financial data.

### BRIEF DESCRIPTION

A system and method provides for analysis and graphical display of a sequential counter for financial data. The system and method includes receiving a plurality of financial data relating to an equity, the financial data including value data of the equity over a plurality of time intervals and selecting a counting algorithm from a plurality of algorithms, for application to the financial data. The system and method further includes detecting a plurality of value steps within financial data, the value steps determined based on parameters of the counting algorithm and performing a sequential counting of the value steps based on the counting algorithm. The method and system further generates a user recommendation for the equity based on the counting and generates a graphical display including the financial data, a secondary display of the sequential counting of the value steps adjacent to the financial data, and the user recommendation.

Further embodiments of the method and system include wherein the sequential counting includes counting one of the value steps of the financial data within a preset number of total value steps, the method and system further including the generation of the secondary display to indicate the one of the value steps relative to the preset number of total value steps. In another embodiment, the method and system includes a number of display markers equal to the present number of total value steps and an active display designation for the value steps having already been counted in the sequential counting as displayed in the second display.

The method and system further includes the display markers including bar displays with a bold display for markers indicating an occurrence of the value step and a light display for markers indicating that an occurrence of the value step has not yet occurred. In another embodiment, the sequential counting includes at least one of: an upward value step counting and a downward value step counting, wherein the secondary display includes display of both at least one upward value step and at least one downward value step. In one embodiment, the counting algorithm includes a counting of 9 value steps and 13 value steps.

The method and system further includes displaying, within the graphical display, a visual representation of a trend in the financial data including at least one of: an almost completed signal and a completed signal, where the signal indicates the occurrences of value steps according to the counting algorithm. In another embodiment, the method and system includes where the user recommendation includes buying the equity, selling the equity, and/or waiting for counting of further value steps relating to the equity.

### BRIEF DESCRIPTION OF THE DRAWINGS

FIG. 1 illustrates a block diagram of a user processing system providing for analysis and graphical display of a sequential counter for financial data;

FIG. 2 illustrates another embodiment of the block diagram of FIG. 1;

FIG. 3 illustrates a flowchart of the steps of one embodiment of a method for analysis and graphical display of a sequential counter for financial data;

FIGS. 4-5 illustrate a sample screenshots of display counters; and

FIGS. 6-7 illustrate a sample screenshots of graphical displays of financial data and display counters in a secondary display.

A better understanding of the disclosed technology will be obtained from the following detailed description of the preferred embodiments taken in conjunction with the drawings and the attached claims.

### DETAILED DESCRIPTION

Embodiments of the disclosed technology comprise systems and methods for analysis and graphical display of sequential counting of financial data to detect and indicate patterns, as well as generate user recommendations relating to transactions associated with the equity.

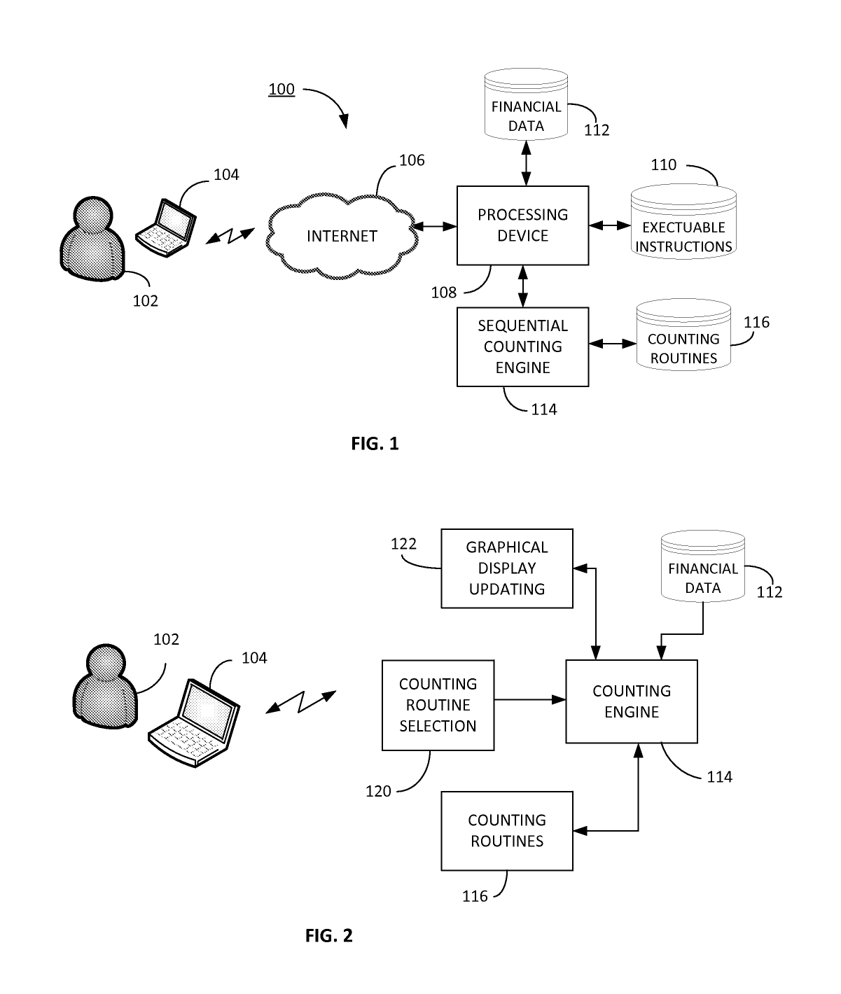

FIG. 1 illustrates one exemplary embodiment of a computing system 100 as described herein. The system 100 includes a user 102, a user computing device 104, a network 106, a processing device 108, executable instructions 110 stored in a memory device, a financial data database 112, a sequential counting engine 114 and a plurality of counting routines 116. It is further recognized by one skilled in the art that additional aspects of the system 100 have been omitted for brevity purposes only.

In the system 100, the user 102 may be any user or group of users. For example, the user may be a financial analyst performing computation analysis on a company's stock. In another example, the user may be a trader or broker buying and selling stocks or other equities for clients or for managing one or more funds. In yet another example, the user may be an individual performing analysis prior to considering or executing trades themselves. The user may be an expert or professional, as well as be a novice to the management and trading systems.

The user device 104 may be any suitable computing device working in either a stand alone or networked environment. For example, the user device 104 may be a laptop or desktop computer running a browser or other type of application for communicating across the network. In another example, the device 104 may be a smart phone, tablet or other mobile computing device running a browser or application for communication and user input/output. In yet another example, the device 104 can be a dedicated terminal for stock and equity management activities.

In one embodiment, the device 104 interfaces across the network 106, whereby processing operations are performed on the network side, in a software-as-a-service manner. In another embodiment, processing operations described below on the network side may also be disposed within the user device 104 or distributed between the network and the device 104.

The network 106 is most generally referred to as the Internet. This network 106 may be any suitable type of network, including but not limited to a local area network, wide area network, virtual private network, among others. In general terms, the network 106 provides for data communication thereacross, including any suitable protocol transmissions and security measures as recognized by one skilled in the art. The network 106 provides the medium for data communication between the device 104 and the processing device 108.

The processing device 108 may be one or more processing devices operative to perform processing operations in response to executable instructions 110. The processing device 108 may be disposed in one or more servers or other network locations, not expressly designated in FIG. 1. The processing operations may be performed in a unitary processing system or in another embodiment may be distributed across one or more processing systems. Whereby, the processing device is operative to perform processing operations described herein such that the user 102 receives a graphical display of the visual analysis of financial data including display of sequential counting routines.

The executable instructions 110 may be software code or other types of instructions readable by the processing device 108, stored in one or more computer readable medium, such as non-transitory medium, including for example one or more data storage devices. The data storage devices may be centrally located or can be accessible in a distributed environment, as recognized by one skilled in the art.

The financial data 112 includes historical data relating to an equity. As used herein, an equity can be any type of stock, equity, fund, fund of funds, or other tradable or exchangeable element having a value affixed thereto. The financial data 112 may be assembled within the system 100 or in another embodiment the data 112 is provided via one or more source providers. For example, the system 100 may include financial data information feeds from market sources providing timely financial data. Thus, the database 112 of FIG. 1 can be illustrative of the data, but it is recognized that in one embodiment, the financial data is provided via one or more data feeds.

The sequential counting engine 114 may be any number of processing devices performing sequential counting routines and calculations. In one embodiment, the engine 114 may be embedded within the processing device 108, but is illustrated separate therefrom in the system 100 for illustration purposes.

Moreover, the engine 114 may be disposed in a processing system separate from the processing device 108, such as via a networked connection. For example, a third party provider may provide sequential counting operation, such that the processing device 108 networks out to the engine 114 for the performance of one or more sequential counting operations. In another example, sequential counting operations may be readily encapsulated within the stock analysis and graphical viewing system, whereby the operations are locally performed relative to the processing device 108 for real time processing.

As described further herein, there are numerous possible sequential counting engine operations. For illustration purposes, FIG. 1 illustrates the database 116 storing the various counting routines executable by the engine 114. Various operations therein can be updated, modified or otherwise adjusted based on the adjustment of the routines in the database 116, as well as the integration of additional routines by inclusion of execution operations of the additional routines in the engine 114.

FIG. 2 illustrates another embodiment of a system for analysis and graphical display of a sequential counter. The system of FIG. 2 provides another embodiment of FIG. 1, including further display of processing elements. The system includes interfacing with the user 102 via computing device 104 similar to techniques in FIG. 1. The network-side processing components of FIG. 2 include a counting routine selection engine 120, counting engine 114, counting routines 116, financial data 112 and an engine for updating the graphical display 122.

The counting routine selection engine 120 provides a user interface allowing the user 102 to select a particular counting routine. The counting routines may be any suitable routine that analyzes the financial data and detects patterns or counts sequences within the data. For example, one sample counting technique may be a nine—thirteen—nine counting technique that predicates the sequence on the occurrence of changes in pricing between time intervals, e.g. from one trading day to the next. As described herein, the pricing between intervals is also referred to as a value step indicating the step in values of the equity between intervals, e.g. the step from the closing price of day one to the closing price of day two.

There are many available sequence techniques available to the user. The sequence techniques may include generally known techniques or can include proprietary techniques. Available counting techniques include but are not limited to a nine count, a thirteen count, a nine-thirteen-nine count, an eighteen count, etc.

The counting routine selection, via the user interface, provides the user 102 the ability to select routines stored in the database 116. In one embodiment, the user 102 may be presented a pull down menu allowing the user to selection the counting sequence from a generated list of available routines. In one embodiment, different user subscription rates to the system 100 of FIG. 1 may indicate availability of counting sequences, e.g. a free subscription may include limited counting sequences and a paid subscription includes more advanced sequences.

From the user selection, the counting engine 114 performs the counting routine operations on the financial data 112, as described in further detail below. In one embodiment, the user 102 is further presented with the ability to select the financial data, whereas additional embodiments for analysis and graphical display presumes the user has preselected the equity or the system has already received said equity financial data.

The counting engine 114 performs the counting operations, including generating recommendations or other analysis of the counting operations. Such counting operations, as well as the underlying financial data 112 are then presented to the user 102 on the computing device 104. Further operations and embodiments of the systems of FIGS. 1 and 2 are describes in further detail below.

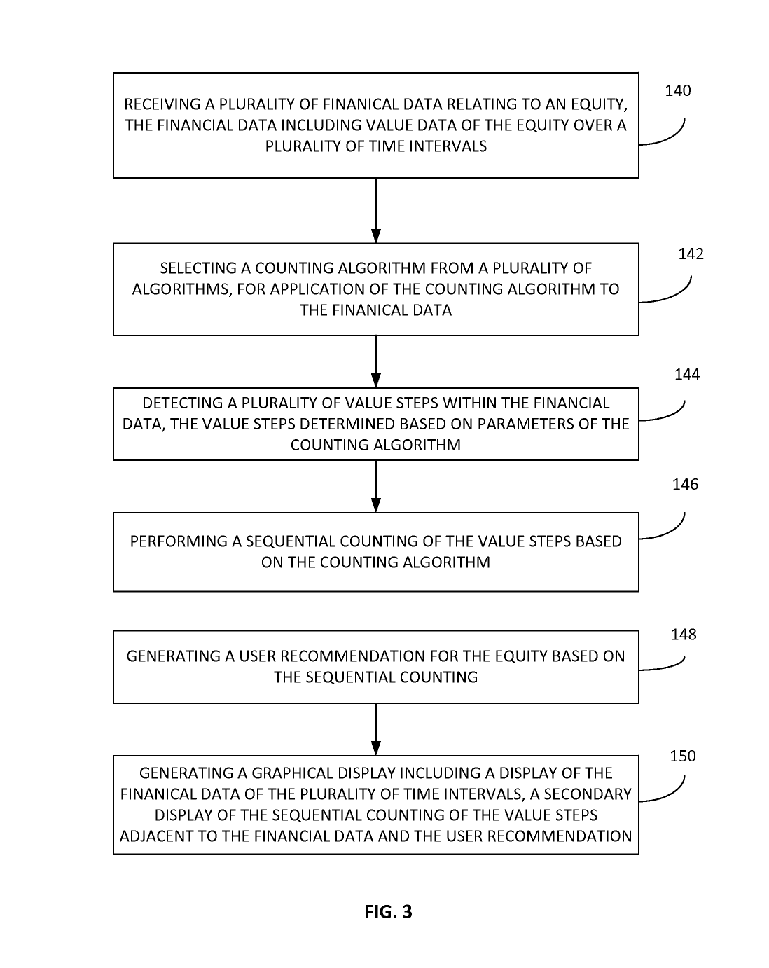

FIG. 3 illustrates a flowchart of the steps of one embodiment of a method for analysis and graphical display of a sequential counter for financial data. In this embodiment, a first step, step 140, is receiving a plurality of financial data relating to an equity, the financial data including value data of the equity over a plurality of time intervals. By way of example, the equity may be a publicly traded stock and the financial data includes the selling price of the stock over a period of time, including daily opening and closing prices, as well as daily high trading points and low trading points. As noted above, in one embodiment, the user may select the equity from a list or may be selected via any other suitable input interface. The financial data may also be received from any suitable source, including for example but not expressly limited to a financial data service or a data feed from the trading market itself.

Step 142 includes selecting a counting algorithm from a plurality of algorithms, for applying the application to the financial data. With reference to FIG. 2, the user 102 selects a counting routine from the available routines 116. In this embodiment, the user 102 selects the algorithm, but the step of selecting may be performed by a processing device or automated system.

As the routine is selected for counting the financial data, step 144 provides for detecting a plurality of value steps within the financial data, the value steps determined based on parameters of the counting algorithm. With reference to FIG. 2, the counting engine 114 reviews the financial data based on the rule or rules of the counting routine. For example, one rule of the counting algorithm may the detection when a closing price increases from one interval to the next or detecting when the price closes at a particular time, therefore the sequence detects this value step by examining concurrent closing prices.

The value steps may also be larger intervals from one trading period to the next. For example, the trading routine may indicate various intermediate steps, in the exemplary embodiment described below.

In FIG. 3, step 146 is performing a sequential counting of the value steps based on the counting algorithm. The sequential counting is in response to the counting rules of the algorithm. For example, one counter routine may be a nine count routine, where the counting rules are predicated on measuring the closing value of a bar compared with the fourth previous bar. With reference to FIGS. 1 and 2, these sequential counting operations may be performed by the processing device 108, the engine 114 in conjunction with the routines 116.

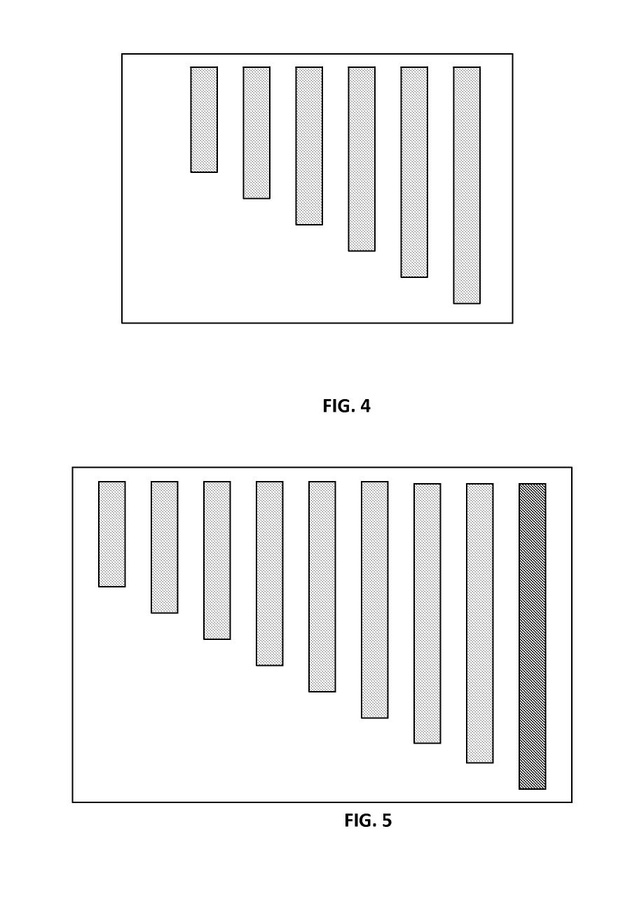

FIG. 4 illustrates a sample screen shot of a representative counting display in a representative six bar signal count. While not expressly illustrated, one embodiment may include coloring of the bars to indicate whether it is a buy or a sell signal count. For example, buy signal counts can be illustrated in green and sell signal counts can be illustrated in red.

FIG. 5 illustrates a sample screen shot of another representative counting display, this display illustrative of a nine bar count. In this example, the final bar is illustrated in a different shading or darker shade or color to indicate the completion of count sequence. For example, in this display, the counting sequence indicates that nine successful counts have consecutively occurred, therefore the ninth occurrence indicates a potential action, such as in a buy count the final step indicates a point to buy the equity and in a sale count, the final step indicates a point to sell the equity.

As described in further detail below, the bar count of the FIG. 4 and FIG. 5 screen shots are then integrated into a display for presentation to the user, including displaying the financial data with the indicator data.

With reference back to FIG. 3, step 148 is generating a user recommendation for the equity based on the sequential counting. As noted above with the sample screen shot of FIG. 5, the user recommendation may be the visual indication of the count bar with different shading or coloring. Where the counting has not completed a count sequence, the user recommendation can be to not perform any actions yet, e.g. do not buy or sell the equity. In one embodiment, the generation of the user recommendation is predicated on the counting operations in response to the counting routine and the indicators for various counting operations as it relates to actions for the underlying equity.

Step 150 is generating a graphical display including a display of the financial data over the various time intervals, a secondary display of the sequential counting of the value steps adjacent to the financial data and the user recommendation. With reference to FIG. 1, the processing device 108 may generate the display for transmission to the user 102 via the network 106. Where additional information updates the display, the graphical display update engine 122 of FIG. 2 may also update the display as appropriate.

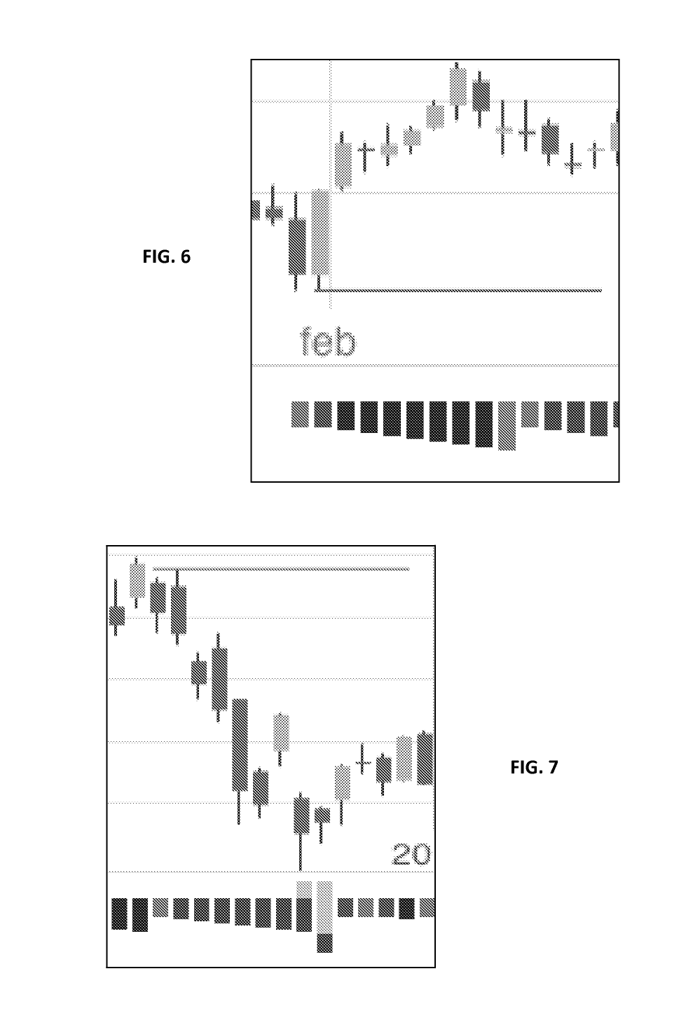

FIG. 6 illustrates a sample screenshot of a graphical display of an equity in a candlestick graph plotting the value of the equity over time. The individual bars of the graph represent individual days and the shading of the bar in the graph represents whether the equity increased or decreased in value during that time period. Adjacent to the graph is the display of count bars indicating a counting sequence. As the counting sequence occurs forward in time, the individual data points on the equity are analyzed relative to corresponding counting rules of the counting routine. If the counting follows the sequence, the bars indicate the presence of the pattern by sequential listing of bars in the secondary display. In this example, the length of successive bars are increased to improve readability. Here, the screenshot illustrates a first occurrence of a first step, such as a buy step. Then, the counting routine detects nine consecutive second steps, such as sell steps. The sequence then transitions back to first steps, and so forth. Thus, the graphical display includes the financial data over various time intervals, the sequential counting display and user recommendation information based on the secondary display.

FIG. 7 illustrates another screen shot of a graphical display. This display includes another example of counting sequences and the secondary display indicating both the counting sequence and a user recommendation. In this example, the display indicates that the counting sequence has continued past a designation point. For example, the first two indicators may be sell indicators and then the next grouping are buy indicators. As the original sequence may be predicated on nine consecutive buy steps, the sequence indicates that the equity had nine step, but on the eight step, another new nine step sequence begun. Thus, the sequence includes user recommendations based on analysis of the counting routine.

Moreover, the generated graphical display improves readability for the user over the prior techniques. The inclusion of the secondary display including the bar counters provides the user with a direct visual representation of the counting sequence and thus the counting operations are not hidden or hard to view within the financial data display. The secondary display also provides the visualization of the user recommendation based on the user's knowledge of the underlying counting sequence.

One example of a counting sequence may be a 13 Count indicator, which expands on a 9 count indicator, as described above, to provide a longer term buy or sell signal. The 13 Count is displayed as the lower row of bars in the 9/13 Count panel. Red bars indicate a sell count while green bars indicate a buy count. The bars increase in length as the count progresses. A bright green or red bar, or a blue bar marks a completed count.

The 13 Count is less rigorous than the 9 Count in two ways. Firstly, it compares the current close with the low/high from two bars earlier (as opposed to 4 bars earlier in the 9 Count). Secondly, unlike the 9 Count, the bars need not be contiguous in the 13 Count. If a market begins moving sideways then the count will simply suspend until the trend resumes or is definitely broken. On the other hand, the 13 Count is more rigorous in that it requires a longer streak (13 as opposed to 9) and it does not begin until a 9 Count has first completed.

The prerequisite for a 13 Count to begin is the completion of a 9 Count. If the 9th bar of the 9 Count satisfies the 13 Count conditions, then it becomes the 1st bar of the 13 Count. You will see this as a small red bar underneath the completed bar of the 9 Count. If the 9th bar does not satisfy the condition then the 13 Count will commence at the first subsequent bar which does satisfy the condition. So you might see the small red bar begin a few days later. 13 total bars must tick off for the 13 Count to complete at which point you will see a full bar in bright red or bright green (or blue, see below).

One further requirement is made of bar 13 in order for the count to complete. The low of bar 13 must be less than or equal to the close of bar 8. Thus, a 13 Count may take some time to complete. This can be referred to as a deferred completion and may indicate that the lows of bar 8 are going to be revisited. If the low of the 13th bar is lower than the low of bar 8 (as opposed to the close) then this indicates a more conservative entry point (better chance to catch the falling knife) and is indicated by a blue bar (regardless of whether the count is buy or sell).

It should be noted that because 13 Count bars need not be contiguous, the pattern for a 13 Count will not necessarily be a steady trend as one would expect from a 9 Count. A completed 13 Count bar may occur significantly off the trend.

A 13 Count will terminate uncompleted if an opposing 9 Count completes. Even if an opposing 9 Count does not complete, if the market exceeds the initial level of the initiating 9 Count then the 13 Count will be terminated. For instance, if during a 13 Count buy pattern the market rallies and posts a low that is higher than the high of the initial 9 Count buy then the 13 Count will be cancelled. This is intuitively obvious as such a condition would be a bullish breakout. A black bar indicates a cancelled count.

One of the nuances of the 13 Count is that it may contain numerous 9 Counts. This makes intuitive sense in a strong trend. The 13 Count may begin anew, that is it may “recycle” depending on whether the more recent 9 Count completions are narrower or wider. To determine whether the 13 Count recycles we examine the “range” of two competing 9 Counts (the difference between the high and low within the 9 Count). The 9 Count with the widest range wins, unless it is greater than 1.618 times the size in which case the narrower count wins. If it is a tie, then the most recent 9 Count wins.

It should be noted that when calculating the “range” of a 9 Count we look at the entire count which may exceed 9 bars. Not until the bars flip (the color) changes do we have the extremes necessary to calculate the range. Recycling is handled automatically in the 13 Count and can be seen when 13 Count bars appear to start over prior to completing.

A 9 Count that extends as far as 18 bars will also automatically recycle the 13 Count. This is an extreme trend condition and invalidates the criteria for a 13 Count.

There are three methods of entering a position based on the 13 Count with increasing degrees of aggressiveness:

1) Enter a position on the next flip, that is the beginning of the next opposing 9 Count, indicating that the reversal is underway.

2) Enter a position on completion of the 13 Count. In this case the 13 Count has completed but we do not yet have confirmation that the reversal is underway. This can achieve a better entry price but has greater risk of slippage.

3) Enter a position on open of market if the open satisfies the 13 Count condition. The risk here is that the 13 Count will not actually complete however some traders consider this a reasonable entry point based on the observation that many 13 Counts will reverse just shy of completion.

An even more robust trend reversal indicator is the so called 9-13-9 count. In this case a completed 13 Count is followed by yet another 9 Count. The qualifications for completion of a valid 9-13-9 are that no opposing 9 Count occurs in between (9 buy, 13 buy, 9 buy without any 9 sell) and there must be a price flip between the completed 13 Count and the final 9 Count (i.e. a fake out). One embodiment of the present system indicates such a condition with a purple bar (regardless of buy or sell).

In another embodiment, the present method and system may used to scan a plurality of equities as an initial assessment tool. In previous embodiments, the user could select the equity for analysis, but one embodiment includes the automated selection of various equities and the general application of the counting sequences to the various equities. From this counting, the system may detect various sequence occurrences, such as the occurrence of a 9-13-9 count. The system may flag the equity then for further user-based analysis.

The method and system described herein provides for the improved analysis and visual feedback for financial information. The inclusion of the secondary display, as well as the visual tick or step indicators provides a readily visible indication of the equity movement, as well as providing a user recommendation based on an understanding of the counting sequence.

In another embodiment, the counting sequence may be applicable to determining fertility in a woman. The charting and analysis techniques described herein may be applicable to determine when a woman is ovulating and the optimal time period for being likely to become pregnant and in the reverse, the optimum time for a woman to not be likely to get pregnant. The value points described above may be female measurements during a monthly cycle and the sequential algorithms are applied to these value points. Therefore, a woman can chart the period for determining either a high likelihood of pregnancy or a greater chance for avoiding an unwanted pregnancy.

FIGS. 1 through 7 are conceptual illustrations allowing for an explanation of the present invention. Notably, the figures and examples above are not meant to limit the scope of the present invention to a single embodiment, as other embodiments are possible by way of interchange of some or all of the described or illustrated elements. Moreover, where certain elements of the present invention can be partially or fully implemented using known components, only those portions of such known components that are necessary for an understanding of the present invention are described, and detailed descriptions of other portions of such known components are omitted so as not to obscure the invention. In the present specification, an embodiment showing a singular component should not necessarily be limited to other embodiments including a plurality of the same component, and vice-versa, unless explicitly stated otherwise herein. Moreover, Applicant does not intend for any term in the specification or claims to be ascribed an uncommon or special meaning unless explicitly set forth as such. Further, the present invention encompasses present and future known equivalents to the known components referred to herein by way of illustration.

The foregoing description of the specific embodiments so fully reveals the general nature of the invention that others can, by applying knowledge within the skill of the relevant art(s) (including the contents of the documents cited and incorporated by reference herein), readily modify and/or adapt for various applications such specific embodiments, without undue experimentation, without departing from the general concept of the present invention. Such adaptations and modifications are therefore intended to be within the meaning and range of equivalents of the disclosed embodiments, based on the teaching and guidance presented herein.

What is claimed is:

1. A method for analysis and graphical display of a sequential counter for financial data, the method comprising:
receiving a plurality of financial data relating to an equity, the financial data including value data of the equity over a plurality of time intervals;
selecting a counting algorithm from a plurality of algorithms, for application to the financial data;
detecting a plurality of value steps within the financial data, the value steps determined based on parameters of the counting algorithm;
performing a sequential counting of the value steps based on the counting algorithm;
generating a user recommendation for the equity based on the sequential counting; and
generating a graphical display including a display of the financial data of the plurality of time intervals, a secondary display of the sequential counting of the value steps adjacent to the financial data, and the user recommendation.

2. The method of 1, wherein the sequential counting includes counting one of the value steps of the financial data within a preset number of total value steps, the method further comprising:
generating the secondary display to indicate the one of the value steps relative to the preset number of total value steps.

3. The method of claim 2, wherein the secondary display includes a number of display markers equal to the present number of total value steps and an active display designation for the value steps having already been counted in the sequential counting.

4. The method of claim 3, wherein the display markers include bar displays with a bold display for markers indicating an occurrence of the value step and a light display for markers indicating that an occurrence of the value step has not yet occurred.

5. The method of claim 2, wherein the sequential counting includes at least one of: an upward value step counting and a downward value step counting.

6. The method of claim 5, wherein the secondary display includes display of both at least one upward value step and at least one downward value step.

7. The method of claim 4, wherein the counting algorithm includes a counting of 9 value steps and 13 value steps.

8. The method of claim 1 further comprising:
displaying, within the graphical display, a visual representation of a trend in the financial data including at least one of: an almost completed signal and a completed signal, where the signal indicates the occurrences of value steps according to the counting algorithm.

9. The method of claim 1, wherein the user recommendation includes at least one of: buy the equity, sell the equity, and wait for counting of further value steps relating to the equity.

10. A system for analysis and graphical display of a sequential counter for financial data, the system comprising:
a computer readable medium having executable instructions stored thereon; and
a processing device, in response to the executable instructions, operative to:
receive a plurality of financial data relating to an equity, the financial data including value data of the equity over a plurality of time intervals;
select a counting algorithm from a plurality of algorithms, for application to the financial data;
detect a plurality of value steps within the financial data, the value steps determined based on parameters of the counting algorithm;
perform a sequential counting of the value steps based on the counting algorithm;
generate a user recommendation for the equity based on the sequential counting; and
generate a graphical display including a display of the financial data of the plurality of time intervals, a secondary display of the sequential counting of the value steps adjacent to the financial data, and the user recommendation.

11. The system of 10, wherein the sequential counting includes counting one of the value steps of the financial data within a preset number of total value steps, the processing device, in response to further executable instructions, further operative to:
generate the secondary display to indicate the one of the value steps relative to the preset number of total value steps.

12. The system of claim 11, wherein the secondary display includes a number of display markers equal to the present number of total value steps and an active display designation for the value steps having already been counted in the sequential counting.

13. The system of claim 12, wherein the display markers include bar displays with a bold display for markers indicating an occurrence of the value step and a light display for markers indicating that an occurrence of the value step has not yet occurred.

14. The system of claim 11, wherein the sequential counting includes at least one of: an upward value step counting and a downward value step counting.

15. The system of claim 14, wherein the secondary display includes display of both at least one upward value step and at least one downward value step.

16. The system of claim 13, wherein the counting algorithm includes a counting of 9 value steps and 13 value steps.

17. The system of claim 10, the processing device, in response to further executable instructions, further operative to:
display, within the graphical display, a visual representation of a trend in the financial data including at least one of: an almost completed signal and a completed signal, where the signal indicates the occurrences of value steps according to the counting algorithm.

18. The system of claim 10, wherein the user recommendation includes at least one of: buy the equity, sell the equity, and wait for counting of further value steps relating to the equity.
